(19) United States
(12) Patent Application Publication
(10) Pub. No.: US 2015/0219246 A1
(43) Pub. Date: Aug. 6, 2015

(54) Polymeric or Composite Interlocking Mount Assembly for Cable Harnesses and Fluid Tubes

(71) Applicant: United Technologies Corporation, Hartford, CT (US)

(72) Inventor: Marc R. Sauerhoefer, Coventry, CT (US)

(21) Appl. No.: 14/515,219

(22) Filed: Oct. 15, 2014

Related U.S. Application Data
(60) Provisional application No. 61/936,443, filed on Feb. 6, 2014.

(51) Int. Cl. F16L 3/10; F16L 3/233; F02C 7/00

(52) U.S. Cl. CPC F16L 3/1091; F02C 7/00; F16L 3/233

(57) ABSTRACT

A kit for building a mount assembly for securing a tubular member to a support structure of a gas turbine engine is described. The kit may comprise a base unit including a bottom surface configured to bond to the support structure and an upper portion with a concave surface. The kit may further comprise a first top unit including a first concave surface with a first diameter and a second top unit including a second concave surface with a second diameter that is smaller than the first diameter. The upper portion of the base unit may be configured to removeably connect to either of a selected one of the first top unit or the second top unit to provide the mount assembly.

### CROSS-REFERENCE TO RELATED APPLICATION

This Application is a non-provisional patent application claiming priority under 35 USC §119(e) to U.S. Provisional Patent Application Ser. No. 61/936,443 filed on Feb. 6, 2014.

### FIELD OF THE DISCLOSURE

The present disclosure generally relates to mount assemblies for securing tubular members to support structures and, more specifically, relates a kit for building a mount assembly for securing a tubular member such as a cable harness or a fluid tube to a support structure in a gas turbine engine.

### BACKGROUND

Gas turbine engines are engines used to provide thrust to an aircraft or to provide power for land-based applications. In general, a gas turbine engine may consist of a fan surrounded by a fan case, a core engine located downstream of the fan, and a nacelle surrounding the fan and the core engine. In supporting fluid transport as well as the electrical operations of the gas turbine engine or an associated aircraft, numerous tubular structures including fluid conduits and electrical cable harnesses may be secured to and mounted on support structures in the gas turbine engine, such as the outer surface of the fan case. The supported fluid tubes may carry gas or liquids, while the electrical cable harnesses may transmit input and output signals required for engine operation or for providing aircraft electrical power.

The tubular structures may be supported on one or more gas turbine engine structures in a carefully designed routing configuration which guides the tubes to their respective destinations or terminals, while optimizing the usage of space and taking into account engine design regulations. In particular, the engine design regulations may establish standards relating to the number of supports required per unit length of the tube depending on its weight, as well as clearance requirements which ensure that the tubular structures are protected against vibrations and abrasions from other structures in the engine and that fluid transport or electrical signal integrity is maintained.

In order to secure and mount tubular structures on gas turbine engine support structures, current approaches use metallic brackets, clamps, and fasteners. A bracket may be fastened to a gas turbine engine support structure and maintain the clamping unit and the cable harness at a fixed distance above the support structure. While such approaches are effective, variations in clearance requirements as well as the diameters/weights of fluid tubes or cable harnesses frequently requires custom designed metallic brackets and clamps to accommodate these variations. However, custom designed metallic brackets and clamps may be associated with undesirable design complexity, high part number count, and high manufacturing costs.

### SUMMARY OF THE DISCLOSURE

In accordance with one aspect of the present disclosure, a mount assembly for securing a tubular member to a support structure of a gas turbine engine is disclosed. The mount assembly may comprise a base unit including a bottom surface configured to bond to a surface of the support structure and an upper portion with a concave surface. It may further include a top unit including a first concave surface with a first diameter. The upper portion of the base unit may be configured to removeably connect to the top unit to provide the mount assembly and the mount assembly may define a clamp for the tubular member between the concave surface of the base unit and the first concave surface of the top unit.

In another refinement, the mount assembly may comprise a kit and the kit may include a second top unit including a second concave surface with a second diameter that is smaller than the first diameter.

In another refinement, the upper portion of the base unit may be configured to removeably connect to either of a selected one of the top unit or the second top unit to provide the mount assembly. The clamp may be formed between the concave surface of the base unit and the selected one of the first concave surface of the top unit or the second concave surface of the second top unit.

In another refinement, the base unit, the first top unit, and the second top unit may each be formed from a polymeric material or a composite material.

In another refinement, a size of the clamp may be adjustable.

In another refinement, the kit may further comprise a plurality of the base units and each of the plurality of base units may have a different height extending between the bottom surface and the upper portion.

In another refinement, the different heights of the plurality of the base units may range from about one inch to about six inches.

In another refinement, the second top unit may comprise an upper frame and an arc-shaped portion extending downwardly from the upper frame and defining the second concave surface.

In another refinement, the first concave surface, the second concave surface, and the concave surface of the base unit may each comprise a plurality of ribs extending axially with respect to a central axis of the tubular member.

In another refinement, the size of the clamp may be adjustable by a toothed connection between the base unit and the selected one of the first top unit or the second top unit.

In another refinement, the base unit may further comprise an arc-shaped portion defining the concave surface and a buckle including internal teeth extending from each end of the arc-shaped portion, and the top unit may further comprise an arc-shaped portion defining the first concave surface and a toothed tab extending from each end of the arc-shaped portion. Each of the toothed tabs may be receivable by a respective one of the buckles.

In another refinement, the second top unit may further comprise a toothed tab extending from each end of the arc-shaped portion of the second top unit, and each of the toothed tabs may be receivable by a respective one of the buckles of the base unit.

In accordance with another aspect of the present disclosure, a gas turbine engine is disclosed. The gas turbine engine may comprise a fan surrounded by a fan case, and a mount assembly securing a tubular member to a surface of the fan case. The mount assembly may comprise a base unit having a bottom surface bonded to a surface of the fan case and an upper portion with a concave surface. The upper portion of the base unit may be connected to a selected one of a first top unit having a first concave surface with a first diameter or a second top unit having a second concave surface with a second diameter that is smaller than the first diameter. The mount assembly may define a clamp for the tubular member between the concave surface of the base unit and the selected one of the first concave surface of the first top unit or the second concave surface of the second top unit.

In another refinement, the base unit, the first top unit, and the second top unit may each be formed from a polymeric material or a composite material.

In another refinement, the base unit may be selected from one of a plurality of base units each having different heights extending between the bottom surface and the upper portion. The different heights of each of the plurality of the base units may range from about one inch to about six inches.

In another refinement, the second top unit may comprise an upper frame and an arc-shaped portion extending downwardly from the upper frame and defining the second concave surface.

In another refinement, the first concave surface, the second concave surface, and the concave surface of the base portion may each comprise a plurality of ribs extending axially with respect to a central axis of the tubular member.

In another refinement, the size of the clamp may be adjustable by a toothed connection between the base unit and the selected one of the first top unit or the second top unit.

In another refinement, the base unit may further comprise an arc-shaped portion defining the concave surface and a buckle having internal teeth extending from each end of the arc-shaped portion. The first top unit may further comprise an arc-shaped portion defining the first concave surface and a toothed tab may extend from each end of the arc-shaped portion of the first top unit. Each of the toothed tabs may be receivable by a respective one of the buckles.

In another refinement, the second top unit may further comprise a toothed tab extending from each end of the arc-shaped portion of the second top unit, and each of the toothed tabs of the second top unit may be receivable by a respective one of the buckles of the base unit.

In accordance with another aspect of the present disclosure, a method for building a mount assembly for securing a tubular member to a support structure of a gas turbine engine is disclosed. The method may comprise selecting a base unit having a desired height from a plurality of base units each having different heights, and bonding a bottom surface of the base unit to a surface of the support structure. The method may further comprise selecting a top unit from one of a first top unit having a first concave surface with a first diameter and a second top unit having a second concave surface with a second diameter that is smaller than the first diameter. In addition, the method may further comprise connecting the top unit to an upper portion of the base unit, and forming a clamp for the tubular member between a concave surface on the upper portion of the base unit and the selected one of the first concave surface of the first top unit or the second concave surface of the second top unit. The method may further comprise adjusting the size of the clamp to accommodate a diameter of the tubular member.

These and other aspects and features of the present disclosure will be more readily understood when read in conjunction with the accompanying drawings.

### BRIEF DESCRIPTION OF THE DRAWINGS

FIG. 1 is a cross-sectional view of a gas turbine engine, constructed in accordance with an embodiment.

FIG. 2 is a perspective view of a support structure of the gas turbine engine of FIG. 1 supporting tubular members in a routing configuration, constructed in accordance with an embodiment.

FIG. 3 is a perspective view of detail 3 of FIG. 2, illustrating a mount assembly for securing a tubular member to the support structure, constructed in accordance with an embodiment.

FIG. 4 is a perspective view similar to FIG. 3, but with the mount assembly having an alternate top unit, constructed in accordance with an embodiment.

FIG. 5 is a front view of a base unit and the top units of the mount assembly shown disassembled and in isolation according to an embodiment.

FIGS. 6A, 6B, and 6C are front views of units of a kit for building the mount assembly, constructed in accordance with an embodiment.

FIG. 7 is a perspective view of detail 7 of FIG. 4.

FIG. 8 is a front view of the clamp assembly of FIG. 4, according to an embodiment.

FIG. 9 is a perspective view of a buckle of the base unit, constructed in accordance with an embodiment.

FIG. 10 is a cross-sectional view through the section 10-10 of FIG. 7, according to an embodiment.

FIG. 11 is a flowchart depicting a series of steps involved in securing the tubular member to the support structure using the kit of FIG. 5, in accordance with an embodiment.

It should be understood that the drawings are not necessarily drawn to scale and that the disclosed embodiments are sometimes illustrated schematically and in partial views. It is to be further appreciated that the following detailed description is merely exemplary in nature and is not intended to limit the invention or the application and uses thereof. In this regard, it is to be additionally appreciated that the described embodiment is not limited to use in conjunction with a particular type of engine, a particular type of support structure, or a particular type of tube. Hence, although the present disclosure is, for convenience of explanation, depicted and described as certain illustrative embodiments, it will be appreciated that it can be implemented in various other types of embodiments and in various other systems and environments.

### DETAILED DESCRIPTION

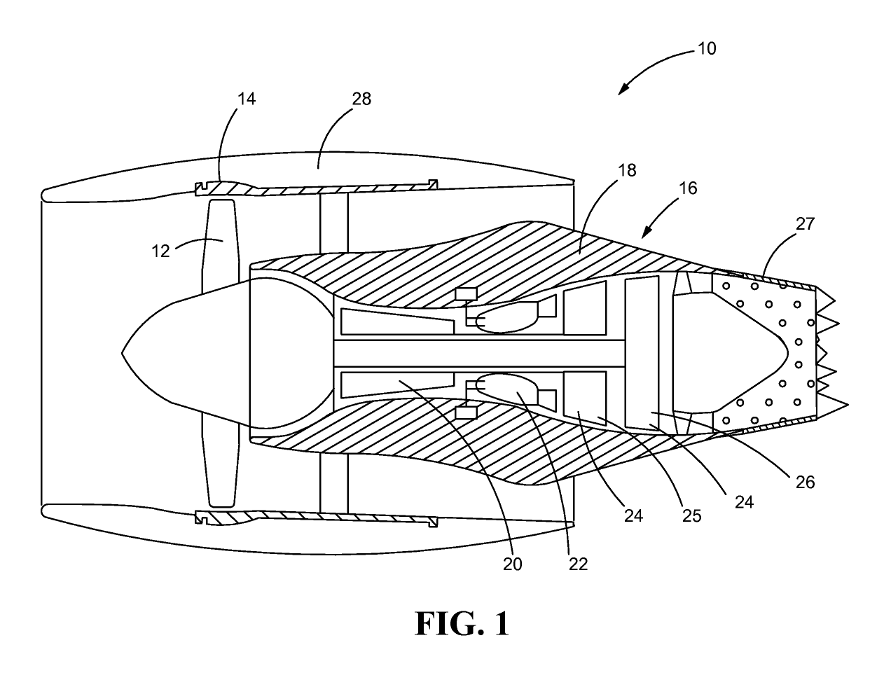

Referring now to the drawings, and with specific reference to FIG. 1, a gas turbine engine 10 is shown. The gas turbine engine 10 may be associated with an aircraft to provide thrust, or it may be used to provide power in other applications. In general, the gas turbine engine 10 may consist of a fan 12 surrounded by a fan case 14, as well as a core engine 16 enclosed in an engine case 18 and located downstream of the fan 12. In a upstream to downstream direction, the core engine 16 may include: 1) a compressor section 20 (which may include a low pressure compressor and a high pressure compressor), 2) an annular combustor 22 (although a series of circumferentially-spaced ‘can’ combustors may also be used), 3) a turbine section 24 (which may include a high pressure turbine 25 and a low pressure turbine 26), and 4) an exhaust nozzle 27. In addition, the fan case 14 and at least a portion of the core engine 16 may be surrounded by a nacelle 28, as shown.

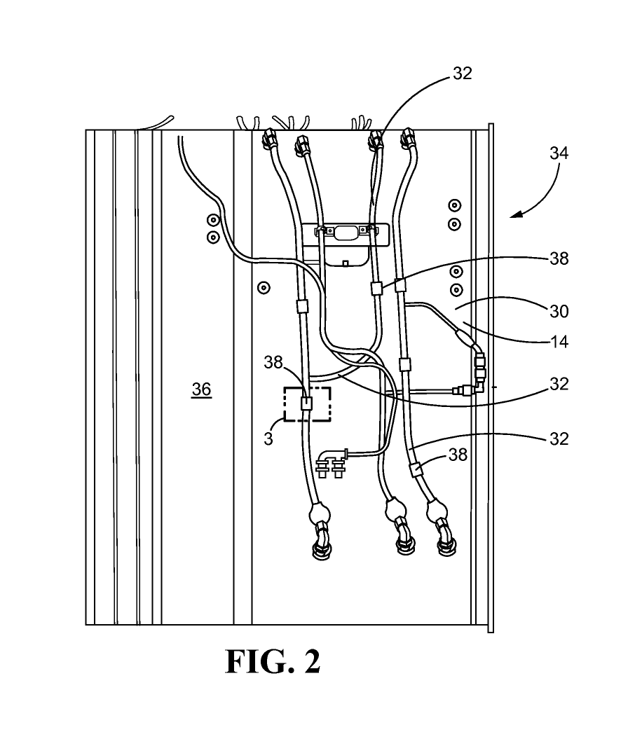

A support structure 30 of the gas turbine engine 10 may be used to support one or more tubular members 32 in a routing configuration 34, as shown in FIG. 2. The tubular members 32 may be fluid tubes for transporting a gas or a liquid, or they may be electrical cable harnesses for transmitting input/output electrical signals required for the operation of the engine 10 and/or an electrical system of an associated aircraft or power generator. In addition, the tubular members 32 may have varying diameters and they may be clustered or branched at varying regions of the routing configuration 34. In some cases, the tubular members 32 may be other types of structures which require mounting on a support structure and may or may not be tubular in shape. The routing configuration 34 may be a designed pathway that guides the tubular members 32 to their destinations or terminals, while providing sufficient clearance between the tubular members 32 and other engine structures so that the tubular members 32 are protected from vibrations or abrasions.

The support structure 30 may be the fan case 14, as shown, but other structures of the gas turbine engine 10 may act as the support structure 30 or may cooperate with the fan case 14 in supporting the tubular member(s) 32 in the routing configuration 34. If the support structure 30 is the fan case 14, the fan case 14 may be formed from a composite material such as a carbon/epoxy composite, or another suitable material. As one possibility, the fan case 14 may support the tubular member(s) 32 on its outer surface 36, as shown in FIG. 2.

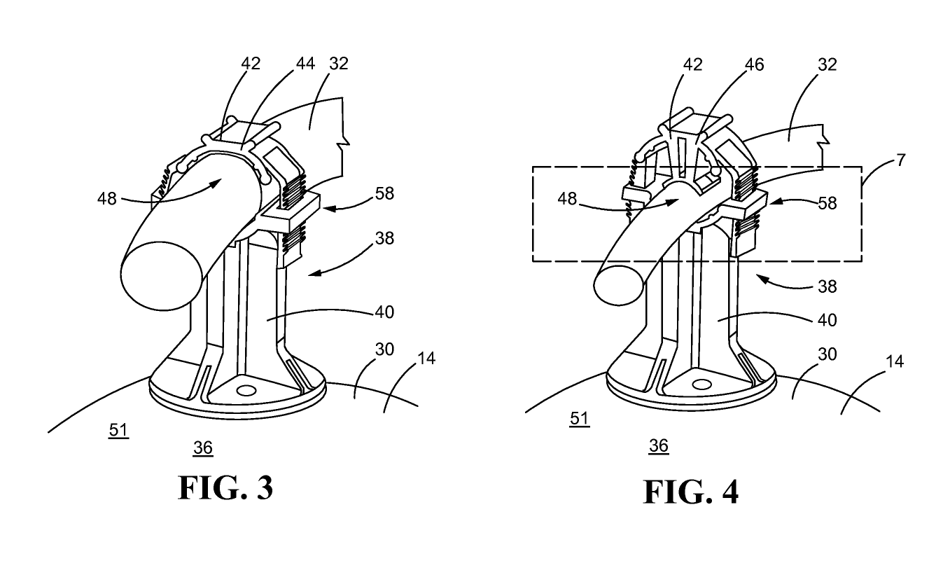

As depicted in FIGS. 2-4, one or more mount assemblies 38 may be used to secure one or more of the tubular members 32 to the support structure 30. The mount assembly 38 may be assembled from a base unit 40 and a top unit 42 which may be selected according to the diameter of the tubular member 32. As will be discussed in more detail below, a first top unit 44 may be selected to accommodate larger tube diameters (see FIG. 3), whereas a second top unit 46 may be selected to accommodate smaller tube diameters (see FIG. 4). In either arrangement, a clamp 48 for securing the tubular member 32 may be formed between the base unit 40 and the selected top unit 42. The mount assembly 38 may be configured to secure tubular members 32 having dimensions ranging between about 0.05 inches (or about 0.13 cm) to about 10 inches (or about 25 cm), although other tube dimensions may also be accommodated in some circumstances.

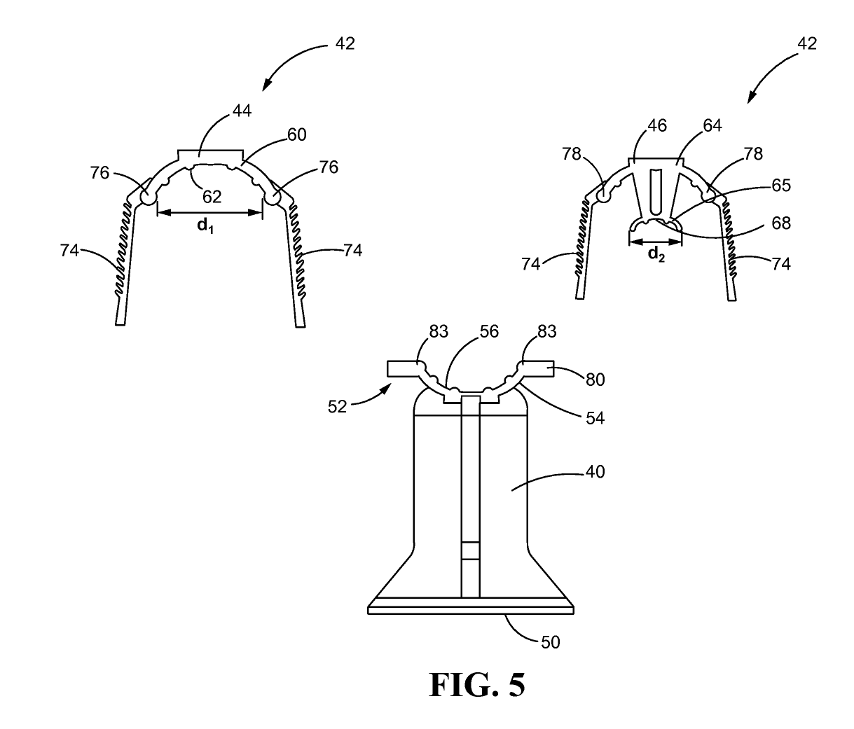

The components of the mount assembly 38 are shown disassembled and in isolation in FIG. 5. The base unit 40 may have a bottom surface 50 configured to bond to a support surface 51, such as the outer surface 36 of the fan case 14. In some arrangements, the bottom surface 50 may have a curvature or shape which mirrors the curvature or shape of the support surface 51 to improve the strength of the bond. As one possibility, the bottom surface 50 may be configured to adhesively bond to the support surface 51 with a suitable vibration-resistant adhesive that is stable at the operating temperature range of the support structure 30. For example, if the support structure 30 is the outer surface 36 of the fan case 14, the adhesive may be stable at the service range typical of the fan case outer surface. In this regard, suitable adhesives may include epoxy paste adhesives which may be stable up to about the service range, elastomeric adhesives, polysulfide adhesives, or other adhesives capable of withstanding the temperature of the environment at the fan case outer surface. As an alternative possibility, the base unit 40 may be configured to bond to the support surface 51 with mechanical fasteners such as bolts or rivets.

The base unit 40 may further include an upper portion 52 having an arc-shaped portion 54 defining a concave surface 56 which may serve to cradle the tubular member 32 in the mount assembly 38. In addition, the upper portion 52 of the base unit 40 may be configured to removeably connect to a selected one of the first top unit 44 or the second top unit 46 to provide the mount assembly 38. In particular, the base unit 40 may be configured to removeably connect to either the first top unit 44 or the second top unit 46 by an interlocking mechanical connection, such as one or more toothed connections 58 (see FIGS. 3-4 and further details below).

The first top unit 44 may include an arc-shaped portion 60 defining a first concave surface 62 which may form a portion of the clamp 48 in the mount assembly 38 (see FIG. 5). In addition, the first concave surface 62 may have a first diameter, d₁, as shown. The second top unit 46 may have an upper frame 64 and arc-shaped portion 65 extending downwardly from the upper frame 64 and defining a second concave surface 68 which may form a portion of the clamp 48 in the mount assembly 38 (see FIG. 4). Notably, the second concave surface 68 may have a second diameter, d₂, that is smaller than the first diameter (d₁) of the first top unit 44. As such, the first top unit 44 may be selected to secure tubular members 32 with larger diameters, and the second top unit 46 may be selected to secure tubular members 32 with smaller diameters. As shown in FIGS. 3-4, the clamp 48 of the mount assembly 38 may be formed between the concave surface 56 of the base unit 40 and the first concave surface 62 of the first top unit 44 (FIG. 3) or the second concave surface 68 of the second top unit 46 (FIG. 4), depending on which top unit 42 is selected.

The components of the mount assembly 38 (the base unit 40, the first top unit 44, and the second top unit 46) may each be formed from a polymeric material or a composite material that is stable at the temperature range of the support surface 51. For example, if the support surface 51 is the outer surface 36 of the fan case 14, the polymeric material or the composite material may be stable at temperatures up to the service range of the support surface 51. Suitable polymeric materials or composite materials may include, but are not limited to, polyetherimide, polyetherimide filled with glass or carbon particles and resin to provide enhanced strength and stability, or a range of other thermoset resins or thermoplastics. However, in some cases, polymeric or composite materials with higher temperature capabilities may also be used such at the mount assembly 38 may be used at higher temperature regions of the gas turbine engine 10. Furthermore, the base unit 40, the first top unit 44, and the second top unit 46 may be formed by a polymer molding technique apparent to those skilled in the art such as injection molding or another suitable molding process. In addition, in some cases, the upper frame 64 of the second top unit 46 may have the same structure as the arc-shaped portion 60 of the first top unit 44 in order to simplify the mold tooling for the components of the mount assembly 38.

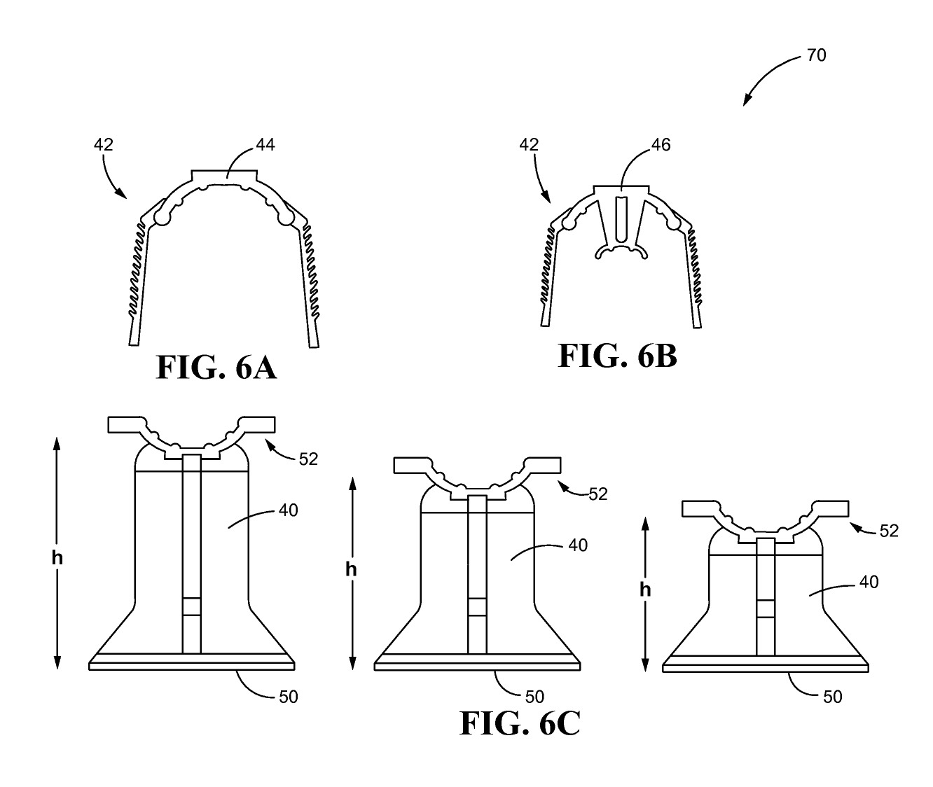

The components of the mount assembly 38 may be provided as a kit 70, as shown in FIGS. 6A-6C. In particular, the kit 70 may allow a user to build the mount assembly 38 according to varying clearance requirements as well as the varying dimensions of the tubular member 32. The kit 70 may include a plurality of the base units 40 each having a different height (h) as measured from the bottom surface 50 to the upper portion 52 (see FIG. 6C). The heights (h) of the base units 40 in the kit 70 may range from about one inch (about 2.5 cm) to about six inches (about 15 cm), although other heights may also be provided in other embodiments. As a non-limiting possibility, the kit 70 may include two or more different base units 40 having different heights (h). The kit 70 may further include a plurality of top units 42 which may include the first top unit 44 and the second top unit 46 (FIGS. 6A-6B). In some cases, the kit 70 may also include additional top units with varying concave surface diameters and/or shapes for accommodating varying tubular geometries.

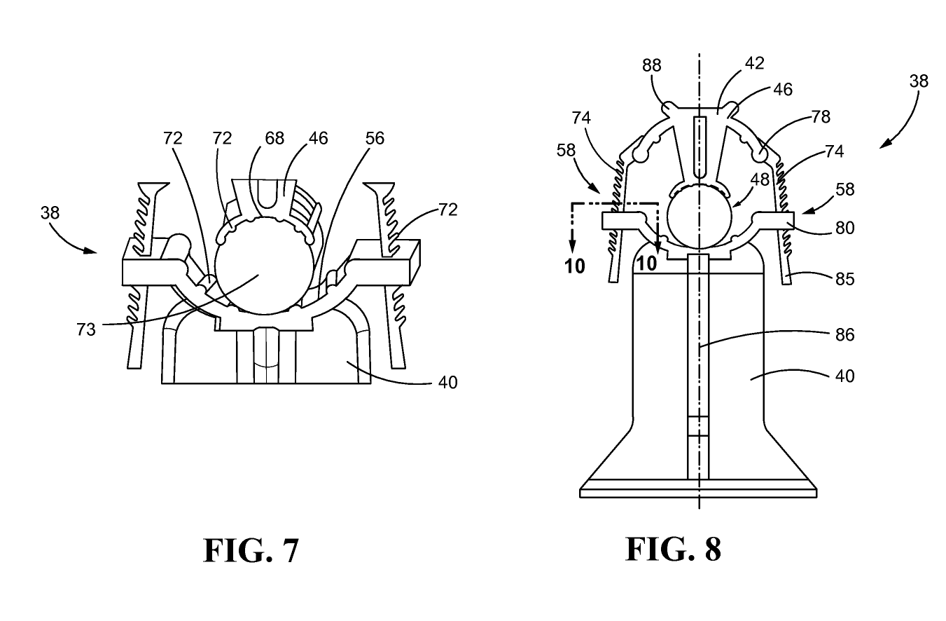

As illustrated in FIG. 7, the concave surface 56 of the base unit 40, the first concave surface 62 of the first top unit 44, and the second concave surface 68 of the second top unit 46 may each include a plurality of ridges 72 which may extend axially with respect to a central axis 73 of a clamped portion of the tubular member 32. The ridges 72 may act to anchor the tubular member 32 in position by assisting to inhibit the rolling of the tubular member 32 in the clamp 48. As will be appreciated, the number and position of the ridges 72 may vary depending on various design considerations.

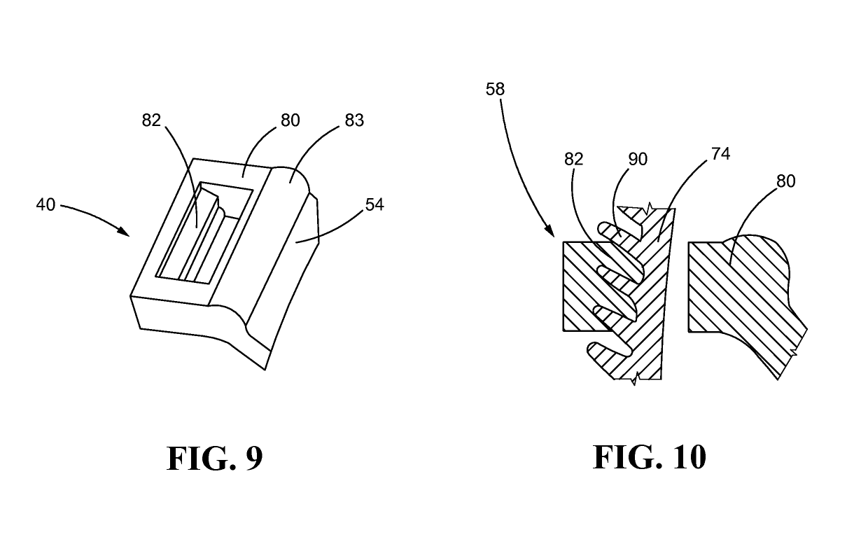

Turning now to FIGS. 8-10, the size of the clamp 48 may be adjustable to accommodate the size of the tubular member 32. This may be achieved by one or more toothed connections 58 between the base unit 40 and either the first top unit 44 or the second top unit 46, although other arrangements may be employed to adjust the clamp size. To provide the toothed connections 58, the first top unit 44 and the second top unit 46 may each have one or more flexible toothed tabs 74, as shown. In particular, the toothed tabs 74 may extend from each end 76 of the arc-shaped portion 60 in the first top unit 44, and they may extend from each end 78 of the upper frame 64 in the second top unit 46 (see FIG. 5). In addition, the base unit 40 may have a buckle 80 with internal teeth 82 extending from each end 83 of the arc-shaped portion 54, as best shown in FIGS. 8-9 and in FIG. 5. The toothed tabs 74 of the selected top unit 42 (i.e., the first top unit 44 or the second top unit 46) may each be receivable by a respective one of the buckles 80 of the base unit 40 to provide the mount assembly 38, as shown in FIG. 8.

To assemble the mount assembly 38 and adjust the size of the clamp 48, the tubular member 32 may be placed on the concave surface 56 of the base unit 40 and each toothed tab 74 of the selected top unit 42 may be inserted into a respective one of the buckles 80. Press-release grips 85 located on each toothed tab 74 may be pressed inward toward a central axis 86 of the mount assembly 38 to assist insertion and/or retraction of the toothed tabs 74 into or out of the buckles 80 to provide the desired clamp size (see FIG. 8). In addition, grips 88 located on an upper portion of the selected top unit 42 may also be used to push or pull the top unit 42 to a desired position. Once the clamp 48 is adjusted to a desired size, the mount assembly 38 and the clamp size may be secured in position by releasing the release grips 85, thereby locking the toothed connection 58 between the internal teeth 82 of the buckle 80 and teeth 90 of the toothed tabs 74, as best shown in FIG. 10. The release grips 85 may be used to release the toothed connection 58 as needed to allow readjustment of the clamp size or replacement or removal of the top unit 42.

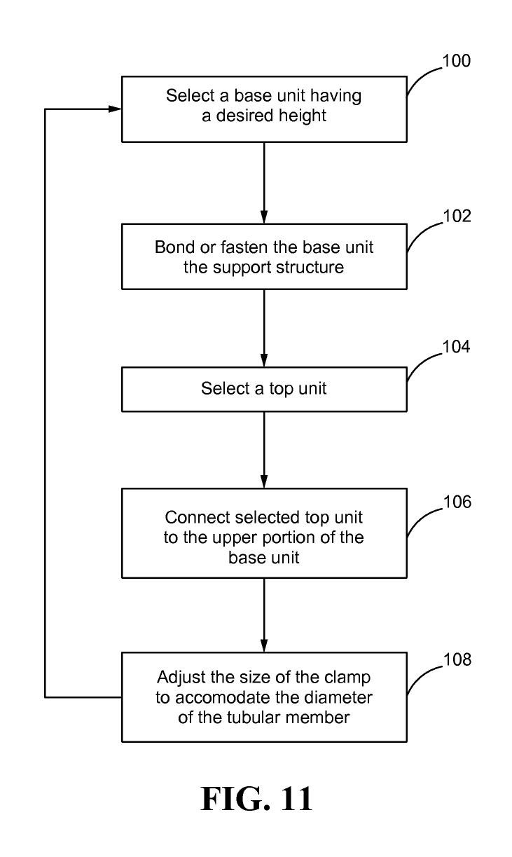

A series of steps which may be involved in securing the tubular member 32 to the support structure 30 using the kit 70 are shown in FIG. 11. Starting with a first block 100, a base unit 40 having a desired height may be selected from the kit 70. The bottom surface 50 of the selected base unit 40 may then be bonded to a selected location on the support surface 51 of the support structure 30 according to block 102. According to a next block 104, a desired top unit 42 may then be selected from the first top unit 44 and the second top unit 46 (and from additional top units, if provided) to appropriately accommodate the diameter of the tubular member 32. The selected top unit 42 may then be connected to the upper portion 52 of the base unit 40 such as by the toothed connection(s) 58 described in detail above (block 106). While connecting the selected top unit 42 to the base unit 40, the clamp 48 may be formed between the concave surface 56 of the base unit 40 and either the first concave surface 62 of the first top unit 44 or the second concave surface 68 of the second top unit 46, depending on which top unit is selected. The size of the clamp 48 may then be suitably adjusted to fit the diameter of the tubular member 32 according to a next block 108. As described in detail above, the block 108 may be carried out by adjusting the toothed connection 58 between the selected top unit 42 and the base unit 40. The steps may be repeated as necessary to build the routing configuration 34, as shown.

Although the present disclosure generally relates to gas turbine engine applications, it will be understood that the mount assemblies disclosed herein may be used in various other applications requiring the mounting of tubular structures on support surfaces such as, but not limited to, automotive applications, commercial appliance applications, and construction applications. These and other alternatives are considered equivalents and within the spirit and scope of this disclosure.

### INDUSTRIAL APPLICABILITY

In general, it can therefore be seen that the technology disclosed herein has industrial applicability in a variety of settings including, but not limited to, gas turbine engines. The mount assembly disclosed herein may be used to secure tubular members such as electrical cable harnesses and fluid tubes to a support structure, such as the outer surface of a fan case in a gas turbine engine. In particular, the mount assembly may be assembled to appropriately accommodate varying tube dimensions and/or clearance requirements using basic building blocks or units provided in a kit. As such, the need for current custom-fabricated metallic brackets and clamps may be reduced or eliminated. The building blocks or units for the mount assembly may be readily molded in a variety of shapes from polymeric materials or composite materials which are stable at the operating temperature range of the supporting structure. In addition, the mount assembly may be lighter in weight and less costly to manufacture than metallic brackets and clamps of the prior art. The technology disclosed herein may find wide industrial applicability in areas such as, but not limited to, aerospace and power generation applications.

What is claimed is:

1. A mount assembly for securing a tubular member to a support structure of a gas turbine engine, comprising:
a base unit including a bottom surface configured to bond to a surface of the support structure and an upper portion with a concave surface; and
a top unit including a first concave surface with a first diameter, the upper portion of the base unit configured to removeably connect to the top unit to provide the mount assembly, the mount assembly defining a clamp for the tubular member between the concave surface of the base unit and the first concave surface of the top unit.

2. The mount assembly of claim 1, wherein the mount assembly comprises a kit, the kit including a second top unit including a second concave surface with a second diameter that is smaller than the first diameter.

3. The mount assembly of claim 2, wherein the upper portion of the base unit is configured to removeably connect to either of a selected one of the top unit or the second top unit to provide the mount assembly, and wherein the clamp is formed between the concave surface of the base unit and the selected one of the first concave surface of the top unit or the second concave surface of the second top unit.

4. The mount assembly of claim 3, wherein the base unit, the top unit, and the second top unit are each formed from a polymeric material or a composite material.

5. The mount assembly of claim 3, wherein a size of the clamp is adjustable.

6. The mount assembly of claim 5, wherein the kit further comprises a plurality of the base units, and wherein each of the plurality of the base units has a different height extending between the bottom surface and the upper portion.

7. The mount assembly of claim 6, wherein the different heights of the plurality of the base units ranges from about one inch to about six inches.

8. The mount assembly of claim 6, wherein the second top unit comprises an upper frame and an arc-shaped portion extending downwardly from the upper frame and defining the second concave surface.

9. The mount assembly of claim 6, wherein the first concave surface, the second concave surface, and the concave surface of the base unit each comprise a plurality of ribs extending axially with respect to a central axis of the tubular member.

10. The mount assembly of claim 8, wherein the size of the clamp is adjustable by a toothed connection between the base unit and the selected one of the top unit or the second top unit.

11. The mount assembly of claim 10, wherein the base unit further comprises an arc-shaped portion defining the concave surface and a buckle including internal teeth extending from each end of the arc-shaped portion, wherein the top unit further comprises and arc-shaped portion defining the first concave surface and a toothed tab extending from each end of the arc-shaped portion, and wherein each of the toothed tabs are receivable by a respective one of the buckles.

12. The mount assembly of claim 11, wherein the second top unit further comprises a toothed tab extending from each end of the arc-shaped portion of the second top unit, and wherein each of the toothed tabs of the second top unit are receivable by a respective one of the buckles of the base unit.

13. A gas turbine engine, comprising:
a fan surrounded by a fan case; and
a mount assembly securing a tubular member to a surface of the fan case, the mount assembly comprising a base unit including a bottom surface bonded or mounted to the surface of the fan case and an upper portion with a concave surface, the upper portion of the base unit being removeably connected to a selected one of a first top unit including a first concave surface with a first diameter or a second top unit including a second concave surface with a second diameter that is smaller than the first diameter, the mount assembly defining a clamp for the tubular member between the concave surface of the base unit and the selected one of the first concave surface of the first top unit or the second concave surface of the second top unit.

14. The gas turbine engine of claim 13, wherein the base unit, the first top unit, and the second top unit are each formed from a polymeric material or a composite material.

15. The gas turbine engine of claim 14, wherein the base unit is selected from one of a plurality of the base units each including a different height extending between the bottom surface and the upper portion, and wherein the different heights range from about one inch to about six inches.

16. The gas turbine engine of claim 15, wherein the second top unit comprises an upper frame and an arc-shaped portion extending downwardly from the upper frame and defining the second concave surface.

17. The gas turbine engine of claim 16, wherein a size of the clamp is adjustable by a toothed connection between the base unit and the selected one of the first top unit or the second top unit.

18. The gas turbine engine of claim 17, wherein the base unit further comprises an arc-shaped portion defining the concave surface and a buckle including internal teeth extending from each end of the arc-shaped portion, wherein the first top unit further comprises and arc-shaped portion defining the first concave surface and a toothed tab extending from each end of the arc-shaped portion, and wherein each of the toothed tabs are receivable by a respective one of the buckles.

19. The gas turbine engine of claim 18, wherein the second top unit further comprises a toothed tab extending from each end of the arc-shaped portion of the second top unit, and wherein each of the toothed tabs of the second top unit are receivable by a respective one of the buckles of the base unit.

20. A method for building a mount assembly for securing a tubular member to a support structure of a gas turbine engine, comprising:
selecting a base unit including a desired height from a plurality of base units each including different heights;
bonding a bottom surface of the base unit to a surface of the support structure;
selecting a top unit from one of a first top unit including a first concave surface with a first diameter and a second top unit including a second concave surface with a second diameter that is smaller than the first diameter;
connecting the top unit to an upper portion of the base unit;
forming a clamp for the tubular member between a concave surface on the upper portion of the base unit and the selected one of the first concave surface of the first top unit or the second concave surface of the second top unit; and
adjusting a size of the clamp to accommodate a diameter of the tubular member.
